(19) United States
(12) Patent Application Publication
(10) Pub. No.: US 2003/0114571 A1
(43) Pub. Date: Jun. 19, 2003

(54) Wet traction in tire treads compounded with surface modified siliceous and oxidic fillers

(76) Inventor: Xiao-Dong Pan, Akron, OH (US)

Correspondence Address: John H. Hornickel, Esq., Bridgestone/Firestone, 1200 Firestone Parkway, Akron, OH, 44317-0001, US

(21) Appl. No.: 09/974,328

(22) Filed: Oct. 10, 2001

(51) Int. Cl. C08K 3/18; C08K 3/22; C08K 3/34; C08K 3/40; C08K 3/04; C08K 9/00

(52) U.S. Cl. 524/492; 523/216; 524/494; 524/430; 524/495

(57) ABSTRACT

The wet traction of a vehicle tire is significantly improved when about 5 phr to about 200 phr of a surface-treated (hydrophobated) siliceous or oxidic filler is included in the vulcanized rubber compound used for the tire tread.

### FIELD OF THE INVENTION

The present invention relates to the use of surface modified siliceous and oxidic fillers in tire treads.

### BACKGROUND OF THE INVENTION

Vehicle tire properties which are important for the user, namely treadwear, wet traction and rolling resistance are, to a large degree, determined by the composition of the tread compound. In the past it has been difficult to improve all three properties at the same time by compounding measures. For example, variations of the grade and amount of reinforcing carbon black alone can improve one or two properties, while adversely affecting the third one. This dilemma has been known as the “magic triangle” of compound development.

The dilemma results, in part, because good rolling resistance which requires low energy loss (at about 50° C.), and good wet traction characteristics which require high energy loss (at about 0° C.), are viscoelastically inconsistent properties. The energy loss of an elastomeric compound is termed hysteresis, which is the difference between the energy applied to deform the compound and the energy released as the compound recovers to its initial undeformed state. Hysteresis is characterized by a loss tangent, tangent delta (tan δ), which is a ratio of the loss modulus to the storage modulus (i.e., the viscous modulus to the elastic modulus) as measured under an imposed sinusoidal deformation.

It has been a long time goal of the tire industry to improve tire wet traction without compromising rolling resistance. The recent use of amorphous precipitated silica as a reinforcing filler has resulted in tire treads having low rolling resistance, while at the same time providing high abrasion resistance. Moreover, tire treads containing silica tend to provide better braking performance than carbon black-containing compounds on wet road surfaces. It has been proposed that the increased wet traction and skid resistance of silica-filled tire tread compounds is due to the polar (hydrophilic) silanol groups on the surface of the silica particles that improve the affinity between the rubber surface and the wet road surface, thereby increasing the coefficient of adhesive friction.

However, the use of silica as a reinforcing filler for tread compounds is known to present problems with filler dispersion in rubber stocks because the surface silanol groups from different particles tend to self-associate, resulting in the formation of silica agglomerates. Although agglomerates are decreased in size during rubber compounding operations, reagglomeration of silica aggregates occurs after compounding, leading to poor silica dispersion and a high compound viscosity. The strong silica filler network results in a rigid uncured compound that is difficult to process in extrusion and forming operations.

Attempts at preparing readily processable, vulcanizable silica-filled rubber stocks containing natural rubber or diene polymer and copolymer elastomers have focused on the use, during compounding, of bifunctional silica coupling agents having a moiety (e.g., a silyl group) reactive with the silica surface, and a moiety (e.g., a mercapto, amino, vinyl, epoxy or sulfur group) that binds to the elastomer. Well known examples of such silica coupling agents are mercaptosilanes and bis-(3-trialkoxysilylorgano) polysulfides, such as bis-(3-triethoxysilyl-propyl) tetrasulfide, which is sold commercially as Si69 by Degussa. However, these silica coupling compounds are expensive and their use requires compounding temperature limitations. As a result, compared with carbon black-filled compounds, tread compounds having good silica dispersion require a longer mixing time at a lower temperature to achieve improved performance, with concomitant decreased production and increased expense.

In another approach to facilitating dispersion of precipitated silica during compound and reducing or preventing reagglomeration of the silica after rubber compounding, it has been reported that precipitated silica can be pretreated with organosilanes that react with the polar silanol groups, resulting in hydrophobated precipitated silica that is stabilized and has less propensity to reform agglomerates.

Commercial hydrophobated fumed silicas, such as those treated with organosilanes or organodisilazanes, and the like, are well known as reinforcing fillers for silicone rubbers, and their use, in lieu of untreated fumed silicas, prevents or reduces “crepe hardening” that would otherwise result from the interaction of silanol groups on the fumed silica surface with the polydiorganosiloxane fluids or gums. Hydrophobated fumed silicas are also known as thickening agents for polar liquids, such as vinyl esters, epoxies and polyurethanes, and rheology enhancers in paints/coatings and adhesives/sealants.

Hydrophobated fumed and precipitated silicas have been proposed for use as reinforcing fillers in natural and synthetic rubber vulcanizates. However, by definition, these treated silicas no longer have substantial numbers of free hydrophilic silanol groups on the surface. As discussed above, it has been proposed that increased wet traction in tire treads containing silica-reinforced rubber compounds is due to the polar silanol groups on the surface of the silica particles that improve the affinity between the rubber surface and the wet road surface, resulting in an increased coefficient of adhesive friction. Therefore, the use of hydrophobated silicas is counter-intuitive if improved wet traction in tire treads containing such compounds is desired.

### SUMMARY OF THE INVENTION

Unexpectedly, it has been discovered that the wet traction of vehicle tires can be significantly improved by the inclusion of a surface-treated, hydrophobated siliceous or oxidic filler such as, but not limited to hydrophobated fumed silica, in sulfur-vulcanized rubber compounds used as tire treads. This finding is very unexpected because virtually all, or at least a plurality of, the free hydrophilic surface silanol groups or hydroxyl groups of the filler have been neutralized by the hydrophobating treatment and, therefore, are not available to contribute to an increased coefficient of adhesive friction between the rubber surface and the wet road surface. Moreover, it has been discovered that the wet traction of tire treads employing rubber compounds containing the hydrophobated siliceous or oxidic filler is significantly improved over the wet traction of tire treads containing non-hydrophobated siliceous or oxidic filler. Surprisingly, the improvement in wet traction is due to the presence of the hydrophobated filler in the tire tread rubber and is not dependent on the presence of non-treated silica and/or carbon black used as reinforcing filler.

In one embodiment of the invention, a vehicle tire having a tread exhibiting improved wet traction comprises a vulcanized rubber compound that comprises 100 parts by weight of an elastomer; about 5 phr to about 200 phr of a surface-treated siliceous or oxidic filler, wherein a plurality of hydroxyl groups on the filler surface prior to surface treatment have been replaced by —OSiR₁R₂R₃ groups, wherein R₁, R₂ and R₃ represent hydrocarbon chains having from one to about 20 carbon atoms; optionally about 5 phr to about 100 phr of an untreated reinforcing filler selected from the group consisting of silica, carbon black, and mixtures thereof, optionally about 0.1% to about 15% by weight of a bifunctional silica coupling agent, based on the weight of the untreated silica; and a cure agent including sulfur. Preferably, at least one of the R₁, R₂ and R₃ groups is a methyl group. More preferably, the R₁, R₂ and R₃ groups are all methyl groups. The surface-treated filler can be present in an amount of about 5 phr to about 120 phr, especially about 10 phr to about 100 phr. Preferably, the tire tread exhibits at least about 5% to about 15% improvement in a wet traction property.

In another embodiment of the invention, the surface-treated filler in the vulcanized rubber compound comprises silica and a plurality of the hydroxyl groups on the filler surface prior to surface treatment have been replaced by trimethylsiloxy groups. In yet another embodiment of the invention, the filler comprises hexamethyldisilazane-treated silica, such as hexamethyldisilazane-treated precipitated silica, fumed silica, colloidal silica, mixtures thereof, and the like. Preferably, the surface-treated silica in the vulcanized rubber compound is hexamethyldisilazane-treated fumed silica.

The invention includes methods to improve the wet traction of tire treads and vulcanizable rubber compositions for use as treadstock in order to improve the wet traction of tire treads.

### BRIEF DESCRIPTION OF THE DRAWINGS

FIG. 1 illustrates the results of a strain sweep test at 10 Hz and 0° C., plotting the tan 6 versus the percent strain, for the rubber compounds reinforced with Aerosil® R812S-treated fumed silica, carbon black (N339), and precipitated silica (HiSil-190G) in the presence of Si69.

FIG. 2 illustrates the results of a strain sweep test at 10 Hz and 70° C., plotting the tan versus the percent strain, for the rubber compounds of FIG. 1.

FIG. 3 illustrates the results of a strain sweep test at 10 Hz and 0° C., plotting the dynamic elastic modulus G′ versus the percent strain, for the rubber compounds of FIG. 1.

FIG. 4 illustrates the results of a strain sweep test at 10 Hz and 70° C., plotting the dynamic elastic modulus G′ versus the percent strain, for the rubber compounds of FIG. 1.

### DETAILED DESCRIPTION OF THE INVENTION

Surface-treated (hydrophobated) siliceous and oxidic fillers suitable for use in the vulcanized rubber compounds for treadstock, according to the invention, include all known natural and synthetic fillers of the appropriate type and include, but are not limited to, precipitated silica, fumed silica, colloidal silica, synthetic silicates, natural silicates, glass fibers, metal oxides, metal carbonates, metal hydroxides, and mixtures thereof.

Precipitated silica suitable for use in an embodiment of the invention has a BET surface area about 30 m²/g to about 500 m²/g prior to surface treatment, a primary particle diameter of about 5 nm to about 200 nm, and a silanol group density (SiOH/nm²) of about 5 to about 6, prior to treatment with the hydrophobating agent. Such precipitated silicas are well known in the art of rubber compounding.

By “fumed silica”, it is meant high-surface area powdered silicas prepared by a pyrogenic process. Such pyrogenic processes can include the flame hydrolysis of halosilanes, such as trichlorosilane and tetrachlorosilane. Other methods can include vaporization of SiO₂, vaporization and oxidation of silicon (Si), and high temperature oxidation and hydrolysis of silicon compounds, such as silicate esters. Fumed silica suitable for use in an embodiment of the invention has a BET surface area of about 50 m²/g to about 400 m²/g, a primary particle diameter of about 7 nm to about 50 nm, and a silanol group density of about 2.5 to about 3.5 (SiOH/nm²), prior to treatment with the hydrophobating agent.

By “colloidal silica” it is meant silica powder consisting primarily of discrete amorphous silica particles having diameters of about 1 nm to about 100 nm and having little aggregate structure. Suitable surface-hydrophobated colloidal silicas for use in an embodiment of the present invention are disclosed in co-owned, copending U.S. patent application Ser. No. 09/487,860, the disclosure of which pertaining to methods of stabilizing colloidal silica is hereby incorporated by reference.

Surface-hydrophobated synthetic silicates useful in embodiments of the invention include, but are not limited to, aluminum silicate, alkaline earth silicates such as magnesium silicate or calcium silicate, with BET surface areas from about 20 m²/g to about 500 m²/g prior to surface treatment, and primary particle diameters from about 5 nm to about 200 nm. Natural silicates include, but are not limited to, kaolin, china clay and calcined clay.

Hydrophobated glass fibers, glass fiber products (such as mats, strands) or glass microbeads are also useful as surface-treated fillers in embodiments of the invention.

The surface-treated fillers also include metal oxides such as, but not limited to, aluminum oxide, titanium dioxide, zirconium dioxide, and the like, and metal carbonates including, but not limited to, magnesium carbonate, calcium carbonate, zinc carbonate, and the like. Metal hydroxides are also useful, including, but not limited to, aluminum hydroxide, magnesium hydroxide, and the like.

The surface-treated fillers may be present in the compositions and compounds according to the invention in any combination of siliceous and metal oxide fillers. For example, surface-treated silica may be present in a mixture with a surface-treated mixed metal oxides, such as aluminum, magnesium, calcium, barium, zinc, zirconium and titanium oxides, and the like.

Alkylation of silica surfaces by synthetic methods leading to the formation of ≡Si—O—Si(CH₃)₃ linkages and, thus, hydrophobation of the surfaces, are well known to those skilled in the art. For example, treatment of precipitated, fumed or colloidal silica with any of a number of different reagents can produce the desired ≡Si—O—Si(CH₃)₃ linkage. Suitable reagents include, but are not limited to, N,N-Diethylaminotrimethylsilane, N-Trimethylsilylpiperidine, N-Trimethylsilylimidiazole, N-Methyl-N-trimethylsilyltrifluoroacetamide, Hexamethyldisilazane, N-Trimethylsilylacetamide, Bis(trimethylsilyl)urea, Trimethylsilylazide, N,O-bis(Trimethyl-silyl)acetamide, N, O-bis(Trimethylsilyl)trifluoroacetamide, O-Trimethylsilylacetate, Trimethylsilyltrifluoroacetate, Trimethylsilyltrimethylfluorosulfonate, Hexamethyldisiloxane, Hexamethyldisilthiane, and the like. Alkylation of silica surfaces using such reagents is described in, for example, Chmielowiec, J. and B. A. Morrow (1983), J. of Colloid and Interface Science 94, pp. 319-327.

Silation of alumina with hexamethyldisilazane is also known to those skilled in the art and is described, for example, in Slavov, S. V., Sanger, A. R. and K. T. Chuang (1998), J. of Physical Chemistry B 102, pp. 5475-5482. Modification of silanol groups on the surfaces of silica, silica-alumina, and aluminum silicate with chlorotrimethylsilane to generate pendant ≡Si—O—Si(CH₃)₃ is described in Slavov, S. V., Chuang, K. T. and A. R. Sanger (1996), J. Physical Chemistry 100, pp. 16285-16292.

Organosilicon modification of glasses, titanium dioxide, magnesium oxide, alumina, zirconium dioxide, silica, and the like, including mixtures thereof such as fumed titania/silica, is described in Gun'Ko, V. M. et al. (1997), J. Adhesion Science and Technology 11, pp. 627-653. For the modification of oxide surfaces, organosilicon compounds can be employed including, but not limited to, XSiR₃, X₂SiR₂, XSi(R₂)R∝Y, where X is Cl, NCO, NCS, N₃, Cn, OR, or the like, and the R groups are hydrocarbon groups.

An exemplary hydrophobated silica suitable for use in the present invention is a hexamethyldisilazane (HMDS) surface-treated fumed silica. For example, HMDS-treated fumed silica is a powder which has been made partially or completely hydrophobic by treatment of filmed silica with HMDS in a continuous, fluidized process by methods well known to those skilled in the art, such as in a fluid-bed reactor. Commercial HMDS-treated fumed silicas suitable for use in embodiments of the invention rubber compounds are available as Aerosil®RX50; Aerosil®R8200; Aerosil®RX300; Aerosil®R812; Aerosil®R812 S from Degussa-Hüls (Ridgefield Park, N.J.), and are derived from untreated fumed silicas Aerosil® OX50; Aerosil®200; Aerosil®300; Aerosil®300; and Aerosil®300, respectively. Other HMDS-treated fumed silicas are commerically available from Wacker-Chemie GmbH (e.g., hydrophobic grades H2000, H3004, H20RM and H30RM) and from Cabot Corporation (e.g., CAB-O-SIL TS-530).

The BET surface area of the HMDS-treated fumed silica suitable for use in the present invention is generally about 50 m²/g to about 400 m²/g. HMS-treated fumed silica having a methanol wettability of about 5% to about 65% is preferred. It is desirable that all or at least a plurality of the surface silanol groups of the silica be reacted and shielded. Depending on the surface area of the silica particles and an estimate of the number of silanol groups per square nanometer of surface area, the molar equivalent of the amount of hydrophobating agent(s) required can be estimated.

Wettability by methanol is a known standard of measuring the degree of hydrophobicity of surface-treated silica and refers to the minimum proportion of methanol (in percent by weight) in a methanol/water mixture which is capable of wetting the filler. The higher the percentage of methanol required to wet the silica the more hydrophobic the silica. For example, HMDS-treated filmed silica Aerosil®TR812S (Degussa-Hüls) and Aerosil®R812 have a methanol wettability of about 35% to about 60%, which values represents a highly hydrophobic silica.

Physical properties of the HMDS-treated Aerosil® fumed silicas are listed in Table 6. An illustration of treatment of hydrophilic (fumed) silica (a) with HMDS (b) is shown below.

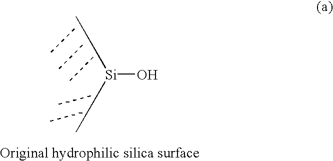

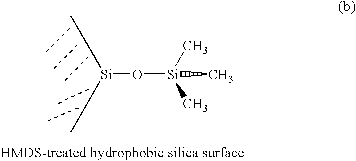

As is known to those skilled in the art, the carbon content of the HMDS-treated fumed silica correlates to the hydrophobicity of the treated filmed silica particle, i.e., the higher the carbon content, the greater the number of surface silanol groups on the silica that have been hydrophobated. In the various embodiments of the invention, the available surface reactive silanol groups can be partially or totally hydrophobated by reaction with the HMDS. By “totally hydrophobated” it is meant reacted to the limit of possibility, taking into account physical limitations such as steric interference, and the like.

The surface-treated hydrophobated siliceous or oxidic fillers described above have particular application as fillers, preferably reinforcing fillers, in rubber compositions useful for tire treads. More particularly, a tire tread comprising a vulcanized rubber compound that comprises a rubber composition employing a surface-treated hydrophobated filler described above will show significant improvement in wet traction. Preferably, the tire tread exhibits at least about 5% to about 15% improvement in wet traction.

The surface-treated hydrophobated siliceous or oxidic fillers can be used in treadstock rubber compositions in conjunction with any solution polymerizable or emulsion polymerizable elastomers. Solution and emulsion polymerization techniques are well known to those of ordinary skill in the art. For example, conjugated diene monomers, monovinyl aromatic monomers, triene monomers, and the like, can be anionically polymerized to form conjugated diene polymers, or copolymers or terpolymers of conjugated diene monomers and monovinyl aromatic monomers (e.g., styrene, alpha methyl styrene and the like) and triene monomers. Thus, the elastomeric products can include diene homopolymers from monomer A and copolymers thereof with monovinyl aromatic monomers B. Exemplary diene homopolymers are those prepared from diolefin monomers having from about 4 to about 12 carbon atoms. Exemplary vinyl aromatic copolymers are those prepared from monomers having from about 8 to about 20 carbon atoms. Copolymers can comprise from about 99 percent to about 10 percent by weight of diene units and from about one to about 90 percent by weight of monovinyl aromatic or triene units, totaling 100 percent. The polymers, copolymers and terpolymers of the present invention can have 1,2-microstructure contents ranging from about 10 percent to about 80 percent, with the preferred polymers, copolymers or terpolymers having 1,2-microstructure content of from about 25 percent to about 65 percent, based upon the diene content. The elastomeric copolymers are preferably random copolymers which result from simultaneous copolymerization of the monomers A and B with randomizing agents, as is known in the art.

Various techniques known in the art for carrying out polymerizations can be used to produce polymers suitable for use in the vulcanizable elastomeric compositions, without departing from the scope of the present invention. Moreover, polymers that are terminally functionalized, or functionalized throughout the polymer backbone, such as with functional groups derived from an anionic polymerization initiator or terminating or coupling agent, are also suitable for use in the invention compositions. Preparation of functionalized polymers is well known to those skilled in the art. Exemplary methods and agents for functionalization of polymers are disclosed, for example, in U.S. Pat. Nos. 5,268,439, 5,496,940, 5,521,309 and 5,066,729, the disclosures of which are hereby incorporated by reference. For example, compounds that provide terminal functionality that are reactive with the polymer bound carbon-lithium moiety can be selected to provide a desired functional group. Examples of such compounds are alcohols, substituted aldimines, substituted ketimines, Michler's ketone, 1,3-dimethyl-2-imidazolidinone, 1-alkyl substituted pyrrolidinones, 1-aryl substituted pyrrolidonones, tin tetrachloride, tributyl tin chloride, carbon dioxide, and mixtures thereof. Other useful terminating agents can include those of the structural formula (R)ₐ ZX_{b}, where Z is tin or silicon. It is preferred that Z is tin. R is an alkyl having from about one to about 20 carbon atoms,; a cycloalkyl having from about 3 to about 30 carbon atoms; and aryl having from about 6 to about 20 carbon atoms, or an aralkyl having from about 7 to about 20 carbon atoms. For example, R can include methyl, ethyl, n-butyl, neophyl, phenyl, cyclohexyl, or the like. X is a halogen, such as chlorine or bromine, or alkoxy (—OR), “a” is an integer from zero to 3, and “b” is an integer from one to 4, where a+b=4. Examples of such terminating agents include tin tetrachloride, tributyl tin chloride, butyl tin trichloride, butyl silicon trichloride, as well as tetraethoxysilane, Si(OEt)₄, and methyl triphenoxysilane, MeSi(OPh)₃. The practice of the present invention is not limited solely to polymers terminated with these agents, since other compounds that are reactive with the polymer bound carbon-lithium moiety can be selected to provide a desired functional group.

Notwithstanding the termination of polymers with alkoxysilane functional groups, as described above, the polymers employed in the present invention, when compounded with surface-treated siliceous or oxidic fillers, as described above, and as particularly exemplified by HMDS-treated fumed silica, do not necessarily require termination with alkoxysilane functional groups. Such termination is known to be useful to facilitate dispersion of hydrophilic silicas by the reaction of the alkoxysilane groups with the silanol groups on the silica surface; whereas the HMDS-treated silica, for example, is already hydrophobated. However, in an embodiment of the invention wherein hydrophilic precipitated or filmed silica and/or carbon black are employed in addition to the surface-treated fillers, alkoxysilane-terminated polymers may be useful to disperse the hydrophilic fillers.

Preferred conjugated diene polymers for use in vulcanizable elastomeric compositions of the invention include, but are not limited to, natural or synthetic polyisoprene, polybutadiene, butadiene-isoprene copolymer, butadiene-isoprene-styrene terpolymer, isoprene-styrene copolymer, solution or emulsion styrene-butadiene copolymer, and the like.

The conjugated diene polymers, or copolymers or terpolymers of conjugated diene monomers and monovinyl aromatic monomers, can be utilized as 100 parts of the rubber in the treadstock compound, or they can be blended with any conventionally employed treadstock rubber which includes natural rubber, synthetic rubber and blends thereof Such rubbers are well known to those skilled in the art and include natural or synthetic polyisoprene rubber, styrene-butadiene rubber (SBR), styrene-isoprene rubber, styrene-isoprene-butadiene rubber, butadiene-isoprene rubber, polybutadiene, butyl rubber, neoprene, ethylene-propylene rubber, ethylene-propylene-diene rubber (EPDM), acrylonitrile-butadiene rubber (NBR), silicone rubber, the fluoroelastomers, ethylene acrylic rubber, ethylene vinyl acetate copolymer (EVA), epichlorohydrin rubbers, chlorinated polyethylene rubbers, chlorosulfonated polyethylene rubbers, hydrogenated nitrile rubber, tetrafluoroethylene-propylene rubber and the like. When the preferred polymers are blended with conventional rubbers, the amounts can vary widely within a range comprising from about one to about 100 percent by weight of the total rubber, with the conventional rubber or rubbers making up the balance of the total rubber (100 parts).

If the polymer has a surface-treated silica predispersed therein, as described below, the amount of the silica dispersed polymers will depend primarily upon the degree of wet traction desired. Preferably, for a tread compound, the silica dispersed polymers comprise about 30 to about 100 parts, based on a total compound formulation having 200 parts. More preferably, the silica dispersed polymers comprise about 80 parts per 200 total part formulation.

Vulcanizable elastomeric compositions of the invention are prepared with the elastomers described above. In particular, in one embodiment of the invention, the vulcanizable elastomeric composition comprises 100 parts by weight of an elastomer; about 5 phr to about 200 phr of a surface-treated siliceous or oxidic filler, wherein a plurality of hydroxyl groups on the filler surface prior to surface treatment have been replaced by —OSiR₁R₂R₃ groups, wherein R₁, R₂ and R₃ represent hydrocarbon chains having from one to about 20 carbon atoms; optionally about 5 phr to about 100 phr of an untreated reinforcing filler selected from the group consisting of silica, carbon black, and mixtures thereof; optionally about 0.1% to about 15% by weight of a bifunctional silica coupling agent, based on the weight of the untreated silica; and a cure agent including sulfur. Preferably, at least one of the R₁, R₂, or R₃ groups is a methyl group. More preferably, R₁, R₂, and R₃ are all methyl groups.

In another embodiment of the vulcanizable elastomeric compositions, the surface-treated siliceous or oxidic filler is surface-treated silica filler, wherein a plurality of hydroxyl groups on the filler surface prior to surface treatment have been replaced by —OSi(CH₃)₃. In yet another embodiment, the silica is HMDS-treated silica. The HMDS-treated silica is present in an amount of about 5 phr to about 200 phr, optionally about 5 phr to about 120 phr, especially about 10 phr to about 100 phr.

In some embodiments, the surface-treated filler is selected from the group consisting of precipitated silica, fumed silica, colloidal silica, and mixtures thereof. In other embodiments, the surface-treated filler is selected from the group consisting of synthetic silicates, natural silicates, glass fibers, metal oxides, metal carbonates, metal hydroxides, and mixtures thereof. In one embodiment, the surface-treated filler is HMDS-treated fumed silica. The HMDS-treated fumed silica is present in an amount of about 5 phr to about 200 phr, optionally about 5 phr to about 120 phr, especially about 10 phr to about 100 phr.

The vulcanizable elastomeric compositions can be prepared by dry mixing in a mixer, such as a Banbury mixer. An exemplary method comprises the steps of (a) mixing together to a drop temperature of about 130° C. to about 200° C. in the absence of added sulfur and cure accelerators, 100 parts by weight of an elastomer, about 5 phr to about 200 phr of a filler comprising HMDS-treated silica; and optionally about 5 phr to about 100 phr of an untreated reinforcing filler selected from the group consisting of silica, carbon black, and mixtures thereof; and optionally about 0.1% to about 15% by weight of a bifunctional silica coupling agent, based on the weight of the untreated silica; (b) allowing the mixture to cool below the mixing temperature; (c) mixing the mixture obtained in step (b) at a temperature substantially lower than a vulcanization temperature, with at least one cure accelerator and an effective amount of vulcanizing agent, such as sulfur, to achieve a satisfactory cure; and (d) curing the mixture obtained in step (c). The compound is usually cured at about 140° C. to about 190° C. for about 5 to about 120 minutes.

The method can further include one or more remill steps in which either no ingredients are added to the first mixture, or non-curing ingredients are added, in order to reduce the compound viscosity and improve the dispersion of the reinforcing filler. The temperature of the remill step(s) is typically about 130° C. to about 175° C., especially about 145° C. to about 165° C. For example, if in the first master batch stage (step a) only a portion of the treated filler and/or only a portion of the reinforcing untreated filler is added, then, in one or more remill steps, the remainder of the treated and/or untreated filler may be added. If a silica coupling agent is used in the first master batch or in a remill step, the maximum temperatures to be attained during each step should be limited appropriately, as known to those skilled in the art of rubber compounding.

The final step of the mixing process is the addition of cure agents to the mixture including an effective amount of sulfur to achieve a satisfactory cure of the final compound. The temperature at which the final mixture is mixed must be below the vulcanization temperature in order to avoid unwanted precure of the compound. Therefore, the temperature of the final mixing step should not exceed about 120° C. and is typically about 40° C. to about 120° C., preferably about 60° C. to about 110° C. and, especially, about 75° C. to about 100° C.

In a preferred embodiment of the invention, a partial amount or all of surface-treated fumed silica is predispersed within the elastomer prior to adding the polymer to the mixer in step (a) of the method. By this method, a polymer prepared as described above is dissolved in a non-polar solvent typically used for anionic solution polymerization. Particularly suitable solvents for dissolving the polymers are aliphatic, cycloaliphatic and aromatic solvents. Hydrocarbons with 2 to 12 carbon atoms are preferred, such as n-butane, iso-butane, n and iso-pentane, hexane, cyclohexane, propene, 1-butene, trans-2-butene, 1-pentene, 2-pentene, 1-hexene, 2-hexene, benzene, toluene, xylene and ethylbenzene. The solvents may be used individually or in the form of mixtures. The polymer may be a coagulated and dried polymer which becomes dissolved in the solvent. Alternatively, the polymer may be in solution after the polymerization process, prior to coagulation and drying. The polymer is mixed with about 5 to about 200 phr, preferably about 10 to about 150 phr, of the surface-treated fumed silica in the solvent, at temperatures ranging from ambient to the boiling point of the solvent, to form a fluidic dispersion of the silica in the polymer. The solvent is subsequently removed by steam distillation at temperatures from 50° C. to 200° C., optionally in a vacuum or under a pressure of from zero to 10 atmospheres.

The content of rubber in the solvent is 0.5 to about 50 percent by weight, the upper limit being determined only by the viscosity of the solution. For economic reasons, the content of rubber should be as high as possible. Particularly preferred concentrations are 5 to 35 percent by weight. Particularly preferred concentrations of the surface-treated filmed silica in the fluidic dispersion are about 10 to about 125 phr.

After drying of the polymer, the treated silica should be visually well-dispersed in the polymer. The silica dispersed polymer is then charged to the mixer for compounding with other ingredients, as described above. Typically all of the surface-treated fumed silica is predispersed in the polymer. However, if only a partial amount of the treated fumed silica has been predispersed, the remaining surface-treated fumed silica may be added to the master batch stage in the dry blending process described above.

The vulcanizable elastomeric compositions containing the surface-treated silica as a filler are preferably free of a bifunctional silica coupling agent, unless they also contain a hydrophilic filler, such as untreated precipitated silica and/or fumed silica. Such additional filler may be desired for additional reinforcement or an extender in the compounds.

The invention provides methods for improving the wet traction of a tire tread, comprising mixing together 100 parts by weight of an elastomer selected from the group consisting of homopolymers of conjugated diene monomers, and copolymers and terpolymers of the conjugated diene monomers with monovinyl aromatic monomers and trienes, about 5 phr to about 200 phr of a surface-treated siliceous or oxidic filler, wherein a plurality of hydroxyl groups on the filler surface prior to surface treatment have been replaced by —OSiR₁R₂R₃ groups, wherein R₁, R₂ and R₃ represent hydrocarbon chains having from one to about 20 carbon atoms, optionally about 5 phr to about 100 phr of an untreated reinforcing filler selected from the group consisting of silica, carbon black, and mixtures thereof; optionally about 0.1% to about 15% by weight of a bifunctional silica coupling agent, based on the weight of the untreated silica; and a cure agent including sulfur; vulcanizing the mixture obtained in (a) to obtain a vulcanized rubber; and producing a tire tread from the vulcanized rubber.

In some embodiments of the methods of the invention, at least one of R₁, R₂ and R₃ is a methyl group. In other embodiments, R₁, R₂ and R₃ are all methyl groups. In some embodiments the surface treatment of the filler is HMDS. In some embodiments, the surface-treated filler is selected from the group consisting of synthetic silicates, natural silicates, glass fibers, metal oxides metal carbonates, metal hydroxides, and mixtures thereof In other embodiments, the surface-treated filler is selected from the group consisting of precipitated silica, fumed silica, colloidal silica, and mixtures thereof.

Tires having these treads will exhibits about 5% to about 15% improvement in a wet traction property compared to the wet traction property of a tire tread comprising the same vulcanized rubber compound in which the surface-treated filler has been replaced at the same filler loading level by the same filler that is not surface treated.

Preferably, the tire treads further exhibit about 7% to about 18% improvement in the wet traction property compared to the wet traction property of a similar tire tread comprising a similar vulcanized rubber compound in which the treated fumed silica is replaced by a precipitated silica or by a precipitated silica in the presence of about 0.1% to about 15% by weight based on the silica of a bifunctional silica coupling agent.

It is generally accepted, that laboratory test results for tan δ at 0° C. are often of limited value for accurate correlation with wet traction testing results, and that identification of high wet traction compounds is largely still a trial-and-error process. One appropriate tire wet traction property measurement is the British Pendulum Skid Tester (BPST) index. According to studies by Guistine & Emerson (The General Tire & Rubber Company, 1983), there is a correlation between the BPST index and tire wet traction testing results. These studies suggested that the results from the BPST exhibited the best correlation with the peak wet braking traction at 60 miles per hour obtained from tires installed on a skid tester trailer. (See Guistine, J. M. and R. J. Emerson, Paper No. 76 presented at the 123^{rd} meeting of the Rubber Division, Inc. of the American Chemical Society, Toronto Canada),

The elastomers can be compounded with all forms of carbon black in a mixture with the silica. The carbon black can be present in amounts ranging from about one to about 100 phr, with about 5 to about 80 phr being preferred. The carbon blacks can include any of the commonly available, commercially-produced carbon blacks, but those having an electron microscope surface area (EMSA) of at least 20 m²/g and, more preferably, at least 35 m²/g up to 200 m²/g or higher are preferred. Surface area values used in this application are determined by ASTM D-1765-01, the standard classification system for carbon blacks used in rubber products, using the BET method. Among the useful carbon blacks are furnace black, channel blacks and lamp blacks. More specifically, examples of useful carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which can be utilized include acetylene blacks. A mixture of two or more of the above blacks can be used in preparing the carbon black products of the invention. Typical suitable carbon blacks are N-110, N-121, N-220, N-339, N-330, N-351, N-550, N-660, as designated by ASTM D-1765-82a. The carbon blacks utilized in the preparation of the vulcanizable elastomeric compositions of the invention can be in pelletized form or an unpelletized flocculent mass. Preferably, for more uniform mixing, unpelletized carbon black is preferred.

The vulcanizable elastomeric compounds of the present invention can be optionally compounded with hydrophilic (untreated) precipitated or fumed silica, in addition to the surface-treated filler, even when that treated filler is hydrophobated silica. The amounts of hydrophilic silica can be present in amounts ranging from about 5 to about 100 phr, with about 5 to about 80 phr being preferred. When hydrophilic silica is present with the surface-treated silica, the amount of surface-treated silica can be decreased to as low as about one phr. When hydrophilic silica is not present, the surface-treated silica must be present in the amount of at least 10 phr.

When hydrophilic silica is present in the vulcanizable elastomeric compounds, it is preferable to include a bifunctional silica coupling agent, in an amount of about 0.1% to about 15% by weight based on the weight of the hydrophilic silica. Such bifunctional silica coupling agents are well known in the art and include, but are not limited to, mercaptosilanes and bis(trialkoxysilylorgano) polysulfides, especially the tetrasulfides and disulfides.

Exemplary mercaptosilanes include, but are not limited to, 1-mercaptomethyl-triethoxysilane, 2-mercaptoethyltriethoxysilane, 3-mercaptopropyltriethoxysilane, 3-mercapto-propylmethyldiethoxysilane, 2-mercaptoethyltripropoxysilane, 18-mercaptooctadecyldiethoxy-chlorosilane, and the like, and mixtures of any of the foregoing. Exemplary bis(trialkoxysilylorgano) tetrasulfide silica coupling agents include, but are not limited to, bis(3-triethoxysilylpropyl) tetrasulfide, bis(2-triethoxysilylethyl) tetrasulfide, bis(3-trimethoxysilylpropyl) tetrasulfide, 3-trimethoxysilylpropyl-N,N-dimethylthiocarbamoyl tetrasulfide, 3-triethoxysilylpropyl-N-N-dimethylthiocarbamoyl tetrasulfide, 2-triethoxysilyl-N,N-dimethylthiocarbamoyl tetrasulfide, 3-trimethoxysilylpropylbenzothiazole tetrasulfide, 3-triethoxysilylpropylbenzothiazole tetrasulfide, and the like, and mixtures of any of the foregoing. Particularly preferred is bis(3-triethoxysilylpropyl) tetrasulfide. Exemplary bis(trialkoxysilyloragno) disulfide silica coupling agents include, but are not limited to, 3,3′-bis(triethoxysilylpropyl)disulfide, 3,3′-bis(trimethoxysilylpropyl) disulfide, 3,3′-bis-(tributoxysilylpropyl) disulfide, 3,3′-bis(tri-t-butoxysilylpropyl) disulfide, 3,3′-bis(trihexoxysilylpropyl) disulfide, 2,2′-bis(dimethylmethoxysilylethyl) disulfide, 3,3′-bis(diphenylcyclohexoxysilylpropyl) disulfide, 3,3′-bis(ethyl-di-sec-butoxysilylpropyl) disulfide, 3,3′-bis(propyldiethoxysilylpropyl) disulfide, 12,12′-bis(triisopropoxysilylpropyl) disulfide, 3,3′-bis(dimethoxyphenylsilyl-2-methylpropyl) disulfide, and the like, and mixtures of any of the foregoing.

In the methods of the invention, the compounding temperatures at which the bifunctional silica coupling agents can be used without resulting in premature scorch of the composition are known to those skilled in the art.

Certain additional fillers can be utilized according to the present invention as processing aids, including mineral fillers, such as clay (hydrous aluminum silicate), talc (hydrous magnesium silicate), aluminum hydrate Al(OH)₃ and mica, as well as non-mineral fillers such as urea and sodium sulfate. Preferred micas principally contain alumina and silica, although other known variants are also useful. The foregoing additional fillers are optional and can be utilized in the amount of about 0.5 to about 40 phr, preferably in an amount of about one to about 20 phr and, more preferably in an amount of about one to about 10 phr.

It is readily understood by those having skill in the art that the rubber composition would be compounded with various commonly used additive materials such as, but not limited to processing oils, zinc oxide, zinc stearate, stearic acid, organosilanes, fatty acid esters of sugars (preferably C₅-C₆ sugars), polyoxyethylene derivatives of the fatty acid esters of the sugars, curing agents, activators, retarders and accelerators, processing additives, such as resins, including tackifying resins, plasticizers, alkyl alkoxysilanes, pigments, additional fillers, fatty acids, waxes, antioxidants, anti-ozonants, and peptizing agents. As known to those skilled in the art, depending on the intended use of the sulfur vulcanizable and sulfur vulcanized material (rubbers), the additives mentioned above are selected and commonly used in conventional amounts.

Accelerators are used to control the time and/or temperature required for vulcanization and to improve properties of the vulcanizate. The vulcanization accelerators used in the present invention are not particularly limited. Examples include thiazol vulcanization accelerators, such as 2-mercaptobenzothiazol, dibenzothiazyl disulfide, N-cyclohexyl-2-benzothiazyl-sulfenamide (CBS), N-tert-butyl-2-benzothiazyl sulfenamide (TBBS), and the like; and guanidine vulcanization accelerators, such as diphenylguanidine (DPG) and the like. The amount of the vulcanization accelerator used is about 0.1 to about 5 phr, preferably about 0.2 to about 3 phr.

Typical amounts of tackifier resins, if used, comprise about 0.5 to about 10 phr, usually about one to about 5 phr. Typical amounts of compounding aids comprise about one to about 50 phr. Such compounding aids can include, for example, aromatic, naphthenic, and/or paraffinic processing oils. Typical amounts of antioxidants comprise about 0.1 to about 5 phr. Suitable antioxidants, such as diphenyl-p-phenylenediamine, are known to those skilled in the art. Typical amounts of anti-ozonants comprise about 0.1 to about 5 phr.

Typical amounts of fatty acids, if used, which can include stearic acid, palmitic acid, linoleic acid or a mixture of one or more fatty acids, can comprise about 0.5 to about 3 phr. Typical amounts of zinc oxide comprise about two to about 5 phr. Typical amounts of waxes comprise about one to about 2 phr. Often microcrystalline waxes are used. Typical amounts of peptizers, if used, comprise about 0.1 to about 1 phr. Typical peptizers can be, for example, pentachlorothiophenol and dibenzoylamidodiphenyl disulfide.

The reinforced rubber compounds can be cured in a conventional manner with known vulcanizing agents at about 0.1 to 10 phr. For a general disclosure of suitable vulcanizing agents, one can refer to Kirk-Othmer, Encyclopedia of Chemical Technology, 3rd ed., Wiley Interscience, N.Y. 1982, Vol. 20, pp. 365 to 468, particularly “Vulcanization Agents and Auxiliary Materials,” pp. 390 to 402. Vulcanizing agents can be used alone or in combination.

The vulcanization is conducted in the presence of a sulfur vulcanizing agent. Examples of suitable sulfur vulcanizing agents include “rubbermaker's” soluble sulfur; sulfur donating vulcanizing agents, such as an amine disulfide, polymeric polysulfide or sulfur olefin adducts; and insoluble polymeric sulfur. Preferably, the sulfur vulcanizing agent is soluble sulfur or a mixture of soluble and insoluble polymeric sulfur. The sulfur vulcanizing agents are used in an amount ranging from about 0.1 to about 10 phr, more preferably about 1.5 to about 5 phr, with a range of about 1.5 to about 3.5 phr being most preferred.

The vulcanized elastomeric compounds produced according to the invention exhibit properties that are indicative of improved wet traction. The compounds of the invention can also be used to form other elastomeric tire components such as subtreads, black sidewalls, body ply skims, bead fillers and the like. However, the compounds are particularly useful in vehicle tire treads. Pneumatic tires incorporating these tire treads can be made according to the constructions disclosed in U.S. Pat. Nos. 5,866,171; 5,876,527; 5,931,211; and 5,971,046, the disclosures of which are incorporated herein by reference.

### EXAMPLES

The following examples illustrate the methods for preparation of the sulfur-vulcanizable elastomeric compositions of the present invention. However, the examples are not intended to be limiting, as other methods for preparing these compositions and different compounding formulations can be determined by those skilled in the art, according to the disclosure made hereinabove. Thus, the invention is not limited to the specific elastomers, surface-treated filler, type of surface treatment of the filler, or other compound ingredients disclosed, nor to any particular amount of an ingredient in the composition. Moreover, the invention is not limited to the specified mixing times or temperatures, or to the stage in which the particular ingredients are added to the mixer. The examples have been provided merely to demonstrate the practice of the subject invention and do not constitute limitations of the invention. Thus, it is believed that any of the variables disclosed herein can readily be determined and controlled without departing from the scope of the invention herein disclosed and described.

### Example 1

### Preparation of Pretreated Polymer Containing Dispersed Hexamethyldisilazane-treated Fumed Silica

a) Polymer Containing Predispersed Aerosil® R812S

Sixty grams of a commercial solution-polymerized styrene-butadiene rubber (SBR, BFS Duradene 706, Bridgestone/Firestone, Inc., Akron, Ohio) or a natural rubber (NR, Standard Indonesian Rubber 20, SIR 20) were cut into pieces and placed in a glass bottle. Thirty grams of Aerosil® R812S (Degussa-Hüls) were added to the bottle. After 680 grams of cyclohexane were poured into the bottle, it was sealed and placed on a shaker until the polymer was completely dissolved. After further shaking for uniform dispersion of the silica into the polymer, the entire fluidic dispersion was released into an aluminum pan under a ventilation hood and was air dried. It was visually observed that the silica was well dispersed inside the dried polymer.

b) Polymer Containing Predispersed Aerosil® R8200

One hundred and twenty grams of BFS Duradene 706 was cut into pieces and placed in a glass bottle. Sixty grams of Aerosil® R8200-treated fumed silica were added to the bottle. After about 1225 grams of cyclohexane were poured into the bottle, it was sealed and placed on a shaker until the polymer was completely dissolved. The entire fluidic dispersion was then released into a glass dish under a ventilation hood and was air dried. It was visually observed that the silica was well dispersed inside the dried polymer.

c) Polymers Containing Predispersed Aerosil®RX50, RX300 or R812

BFS Duradene 706 was pretreated with Aerosil® RX50, Aerosil® RX300 or Aerosil® R812 according to either one of the above methods. In each case, it was visually observed that the silica was well dispersed inside the dried polymer.

### Example 2

### Stock Rubber Formulations

In order to demonstrate the methods of preparation and properties of the vulcanizable elastomeric compositions for use in tire treads according to the invention, fourteen stocks of rubbers were prepared using the compounding formulations shown in Tables 1 and 2, for SBR and NR polymers, respectively, and mixing conditions shown in Table 3. With the exceptions described below, the stocks were prepared under similar mixing conditions, but with some adjustments in the curing package.

Stocks T-1, T-2, T-3, T-4 and T-5 were test formulations employing SBR and 50 phr of HMDS-treated fumed silicas Aerosil®RX50, R8200, RX300, R812 and R812S, respectively, predispersed in the SBR, as described in Example 1. The “pretreated” SBR was charged to the mixer at 0 seconds in the master batch mixing stage. Accordingly, the step of charging treated fumed silica at 30 seconds was omitted. An acceptable alternate method of mixing polymer and treated fumed silica is by dry blending, wherein the polymer is charged to the mixer, followed by charging of the treated fumed silica.

Comparative SBR stocks C-1 and C-2 were reinforced with 50 phr of carbon black (N339) and differed in the amount of sulfur employed for cure. In general, 1.3 phr sulfur is sufficient for carbon black cured stocks; however, the N339-reinforced stock containing 3 phr sulfur was employed to demonstrate that the BPST index was not affected by this amount of sulfur used. Comparative SBR stock C-3 was reinforced with 50 phr of amorphous precipitated silica (HiSil 190G) and 5 phr of the pure silica coupling agent Si69 (10% by weight, based on the silica) was added. The Si69 was a commercially available product, X50S (Degussa-Hüls) carried 1:1 on carbon black (10 phr of X50S was employed to produce 10% by weight of Si69). Because some crosslinking sulfur becomes available from the Si69, the amount of added sulfur was decreased to 1.15 phr.

Test SBR stock T-6 employed 80 phr of the HMDS-treated fumed silica RX300 predispersed in SBR. Comparison SBR stocks C-4 and C-5 were dry blended untreated polymers reinforced with 80 phr of amorphous precipitated silica (HiSil 190G). C-5 employed the silica coupling agent Si69 (10% by weight, based on the silica), whereas C-4 was prepared without Si69.

Test stock T-7 was a test formulation employing natural rubber (NR) and 50 phr of HMDS-treated fumed silica R812S, predispersed in the NR, as described in Example 1. The “pretreated” NR was charged to the mixer at 0 seconds in the master batch mixing stage. Accordingly, the step of charging treated fumed silica at 30 seconds was omitted. As described above, an acceptable alternate method of mixing the natural rubber and treated fumed silica is by dry blending, wherein the natural rubber is charged to the mixer, followed by charging of the treated fumed silica.

Comparison stocks C-6 and C-7 were natural rubber reinforced with 50 phr of carbon black (N339) or 50 phr of HiSil 190G, respectively.

All test and comparison stocks were molded and cured into sheets, test specimens for BPST testing and cylindrical buttons at 165° C. The cure times for each compound are listed in Tables 1 and 2.

TABLE 1
Formulations of SBR Stock Rubbers

| Ingredient (phr) | C-1 | C-2 | C-3 | T-1 | T-2 | T-3 | T-4 | T-5 | C-4 | C-5 | T-6 |
|---|---|---|---|---|---|---|---|---|---|---|---|
| SBR* | 100 | 100 | 100 | 100 | 100 | 100 | 100 | 100 | 100 | 100 | 100 |
| Filler (50 phr) | N339 | N339 | HiSil 190G | Aerosil RX50 | R8200 | RX300 | R812 | R812S | | | |
| Filler (80 phr) | | | | | | | | | 190G | 190G | RX300 |
| Paraffinic oil | 10 | 10 | 10 | 10 | 10 | 10 | 10 | 10 | 10 | 10 | 10 |
| Antioxidant*** | 1 | 1 | 1 | 1 | 1 | 1 | 1 | 1 | 1 | 1 | 1 |
| Stearic acid | 2 | 2 | 2 | 2 | 2 | 2 | 2 | 2 | 2 | 2 | 2 |
| X50S (Si69)^{†} | 0 | 0 | 10 | 0 | 0 | 0 | 0 | 0 | 0 | 16 | 0 |
| Zinc oxide | 3 | 3 | 3 | 3 | 3 | 3 | 3 | 3 | 3 | 3 | 3 |
| DPG** | 0.5 | 0.5 | 0.5 | 0.5 | 0.5 | 0.5 | 0.5 | 0.5 | 0.8 | 0.8 | 0.8 |
| MBTS** | 1 | 1 | 1 | 1 | 1 | 1 | 1 | 1 | 1 | 1 | 1 |
| TBBS** | 0 | 1 | 1 | 1 | 1 | 1 | 1 | 1 | 1 | 1 | 1 |
| Sulfur | 1.3 | 3 | 1.15 | 3 | 3 | 3 | 3 | 3 | 3 | 1.15 | 3 |
| Cure time at 165° C. (min) | 15 | 10 | 20 | 14 | 18 | 20 | 34 | 18 | 30 | 22 | 12 |

*BFS Duradene 706, T_{g} = −62° C.
**DPG = Diphenylguanidine; MBTS = 2,2′-dithiobis(benzothiazole); TBBS = N-tert-butyl-2-benzothiazole sulfenamide
***N-(1,3-dimethylbutyl)-N′-phenyl-p-phenylenediamine
^{†}Si69 carried 1:1 on carbon black (X50S, Degussa-Hüls)

TABLE 2
Formulations of NR Stock Rubbers

| Ingredient (phr) | C-6 | C-7 | T-7 |
|---|---|---|---|
| Natural Rubber* | 100 | 100 | 100 |
| Filler (50 phr) | N339 | HiSil-190G | Aerosil R812S |
| Paraffinic oil | 10 | 10 | 10 |
| Antioxidant | 1 | 1 | 1 |
| Stearic acid | 2 | 2 | 2 |
| X50S (Si69)^{†} | 0 | 10 | 0 |
| Zinc oxide | 3 | 3 | 3 |
| DPG** | 0 | 0.5 | 0.5 |
| MBTS** | 0 | 1 | 1 |
| TBBS** | 0.8 | 1 | 1 |
| Sulfur | 1.3 | 1.15 | 3 |
| Cure time at 165° C. | 12 | 12 | 9.5 |
| (min) | | | |

*SIR 20 natural rubber
**DPG = Diphenylguanidine; MBTS = 2,2′-Dithiobis(benzothiazole); TBBS = N-tert-butyl-2-benzothiazole sulfenamide
^{†}Si69 carried 1:1 on carbon black (X50S, Degussa-Hüls)

TABLE 3
Mixing Conditions for Dry Blending

| | |
|---|---|
| Mixer | 65 g Brabender |
| Agitation Speed | 50-90 rpm |

Master Batch Stage

| | |
|---|---|
| Initial Temperature | 90-110° C. |
| 0 seconds | Charging polymers (or pre-treated polymers, |
| | see Example 1) |
| 30 seconds | Charging treated fumed silica or carbon black or |
| | precipitated silica, and all pigments. |
| 5 min | Drop |
| Drop temperature | 126-157° C. |

Remill Stage

| | |
|---|---|
| Initial Temperature | 90-110° C. |
| 0 seconds | charging master batch stock and Si69 (if used) |
| Drop Temperature | 126-150° C. (Drop at 4 minutes or at 150 C.) |

Final Stage

| | |
|---|---|
| Initial Temperature | 69-82° C. |
| 0 seconds | charging remilled stock, and curing agent, |
| | including accelerators |
| Drop Temperature | 90-110° C. (Drop at 1 minute, 30 seconds or at 110 |

TABLE 4
Physical Properties of the Cured SBR Compounds

| | Compound | | | | | | | | | | | |
|---|---|---|---|---|---|---|---|---|---|---|---|---|
| | | | C-3 | | | | | | C-4 | C-5 | | |
| | C-1 | C-2** | HiSil- | T-1 | T-2 | T-3 | T-4 | T-5 | HiSil- | HiSil- | T-6 | |
| | N339 | N339 | 190G | RX50 | R8200 | RX300 | R812 | R812S | 190G | 190G^{§} | RX300 | |
| BPST Index* | 56 | | 61 | | | | | 65.5 | | | | |
| (from different tests) | 54 | | | | 62 | | | | | | | |
| | | 55.5 | | 60.5 | | 65 | 65 | | | | | |
| | 55 | | 61.5 | | | | | | 60 | 64.5 | 71 | |
| Shore A hardness (peak) | | | | | | | | | | | | |
| At 23° C. | 62.6 | 70.9 | 69.4 | 56.6 | 58.9 | 62.2 | 63.6 | 61.5 | 93.8^{§§} | 82.7 | 72.7 | |
| At 50° C. | 59.1 | 69.7 | 66.4 | 55.9 | 56.5 | 60.7 | 61.2 | 59.9 | 91.5^{§§} | 79.7 | 69.1 | |
| Tangent Delta at 10 Hz | | | | | | | | | | | | |
| 0° C., 0.50% | 0.159 | 0.144 | 0.149 | 0.202 | 0.182 | 0.180 | 0.168 | 0.180 | 0.086 | 0.156 | 0.172 | At ˜1.4° C. |
| 0° C., 6.0% | 0.247 | 0.219 | 0.244 | 0.266 | 0.351 | 0.335 | 0.291 | 0.368 | ND*** | 0.286 | 0.456 | |
| 50° C., 0.50% | 0.150 | 0.087 | 0.130 | 0.075 | 0.091 | 0.097 | 0.103 | 0.094 | 0.075 | 0.202 | 0.199 | At 2.0%, |
| | | | | | | | | | | | | ˜50.5° C. |
| 50° C., 6.1% | 0.200 | 0.125 | 0.178 | 0.101 | 0.162 | 0.171 | 0.171 | 0.175 | ND** | 0.221 | 0.281 | |
| Ring tensile test at room temp | | | | | | | | | | | | |
| Modulus 50% (psi) | 160.7 | 269.0 | 195.0 | 139.0 | 139.0 | 146.1 | 142.6 | 136.5 | 515.0 | 316.5 | 186.1 | |
| Modulus 100% (psi) | 268.5 | 616.3 | 331.7 | 221.0 | 209.3 | 212.8 | 204.7 | 198.0 | 743.2 | 533.7 | 261.7 | |
| Modulus 200% (psi) | 623.3 | 1715 | 731.6 | 403.7 | 410.5 | 400.0 | 366.4 | 362.3 | 1309 | 1206 | 457.4 | |
| Modulus 300% (psi) | 1162 | — | 1317 | — | 691.2 | 677.8 | 592.2 | 617.5 | — | 2243 | 731.9 | |
| Tensile at break (psi) | 3044 | 2453 | 3142 | 623.1 | 1354 | 1379 | 1586 | 1516 | 2054 | 2548 | 1601 | |
| % strain at break | 570.0 | 257.5 | 515.8 | 287.2 | 434.6 | 448.4 | 546.1 | 490.0 | 302.5 | 329.7 | 485.4 | |

*British Pendulum Skid tester Index;
**Compound C-2 was cured with more sulfur than C-1 (i.e., 3 phr instead of 1.3 phr);
***ND = not determined because too high a torque was required, beyond the capability of the instrument employed;
^{§}HiSil-190G and coupling agent Si69;
^{§§}For reference only. Over the upper gate for reading for the hardness tester used.

TABLE 5
Physical Properties of the Cured NR Compounds

| | Compound | | |
|---|---|---|---|
| | C-6 | C-7 | T-7 |
| | N339 | HiSil-190G | R812S |
| BPST Index* | 61 | 66 | 70 |
| Shore A hardness (peak) | | | |
| At 0° C. | 57.7 | 65.3 | 58 |
| At 23° C. | 57 | 64 | 56.4 |
| At 50° C. | 53.6 | 62.1 | 55 |
| Tangent Delta at 10 Hz | | | |
| 0° C., 0.50% | 0.160 | 0.134 | 0.148 |
| 50° C., 0.50% | 0.139 | 0.0968 | 0.0924 |
| 0° C., 6.0% | 0.238 | 0.225 | 0.267 |
| 50° C., 6.1% | 0.168 | 0.156 | 0.143 |

*British pendulum skid tester index.

### Example 3

The wet traction of each of the test and comparison compounds was measured by the British Pendulum Skid Tester according to ASTM E303-93. The test was performed at room temperature on a concrete block with a water thickness of approximately 1.0 mm. The sixth reading for each test was usually reported.

The results of separate testing of test compounds versus comparison compounds are presented as the British Pendulum Skid Tester index (“BPST index”) values in Tables 4 and 5. The BPST index of the 50 phr Aerosil®R812S-treated fumed silica filled sample T-5 was 17% higher than that of the 50 phr carbon black filled comparison samples C-1 and C-2, whereas the BPST index of the 50 phr precipitated silica filled sample C-3 was only 9% increased over the carbon black filled sample C-1. The BPST index of the Aerosil® R812S-treated fumed silica sample was also 7.4% higher than that of the precipitated silica filled sample C-3. These results support findings by others that the use of precipitated silica as a reinforcing filler increases the wet traction of tire tread compounds. However, these results also surprisingly show that the use of HMDS hydrophobated fumed silica significantly increases the wet traction of tire tread compounds over that obtained with precipitated silica filled compounds.

The BPST index of the 50 phr Aerosil® R8200-treated fumed silica filled sample T-2 was 15% higher than the BPST index of the corresponding carbon black filled sample C-1. Further, the test compounds T-3 and T-4, filled with 50 phr Aerosil®RX300 and R812, respectively, showed 17% increase in the BPST index over the carbon black filled comparison sample C-2, and test compound T-1, filled with 50 phr Aerosil®RX50 showed a 9% increase in the index over C-2. Although cured with more sulfur than usual, the carbon black filled compound C-2 did not show a higher BPST index than the comparison carbon black filled compound C-1.

From the above results, it can be concluded that the wet traction of tire tread compounds that are reinforced with the DS-treated fumed silica according to the invention, improves as the surface area of the treated silica increases (RX50<RX8200≦RX300≈R812≈R812S, see Table 6).

It can also be concluded that the wet traction also improves as the amount of HMDS-treated fumed silica filler increases. For example, the BPST index of test compound T-6 containing 80 phr of HMS-treated fumed silica showed about an 8% increase compared to test compound T-5 containing 50 phr of the treated fumed silica. Moreover, test compound T-6 containing 80 phr of the treated fumed silica showed an 18% increase in the BPST index compared to a similar compound containing 80 phr of a precipitated silica without Si69 coupling agent, and a 10% increase in the wet traction index compared to the 80 phr precipitated silica filled compound C-5 treated with Si69. The 10% increase in BPST index can be compared to the treated fumed silica filled compound T-5 in which only 50 phr of the treated silica was employed, and the compound T-5 showed a 7.4% increase in the BPST index over the comparison compound C-3 in which 50 phr of precipitated silica was employed. Therefore, tire treads employing compounds having increased amounts of HMDS-treated fumed silica as reinforcing filler can be expected to show better wet traction.

As illustrated in Table 5, the improvement in tire tread wet traction is not limited to synthetic rubber (i.e., SBR). Test compound T-7 containing natural rubber and 50 phr of Aerosil®R812S-treated fumed silica as reinforcing filler showed a significant increase in BPST index of 15% over the carbon black filled compound C-6, and an increase of 6% over the precipitated silica filled compound C-7. As expected, C-7 also showed an increase of 8% in BPST index over carbon black filled compound C-6.

### Example 4

The Shore A hardness of each sample was measured according to ASTM D2240 and listed in Table 4 for the SBR compounds and Table 5 for the NR compound. The HMDS-treated fumed silica filled compounds T-1 through T-5 and T-7 are all softer than the comparison precipitated silica filled compounds C-3 and C-7, as measured by the peak Shore A hardness at 23° C. and 50° C. T-3 (RX300), T-5 (R812S) and T-7 (R812S) have approximately the same hardness as the carbon black filled compounds C-1 and C-6 at all tested temperatures.

TABLE 6
Selected Properties of HMDS-treated Fumed Silicas

| Property | Aerosil RX50 | Aerosil 8200 | Aerosil RX300 | Aerosil R812 | Aerosil R812S |
|---|---|---|---|---|---|
| BET (m²/g) | 30-50 | 135-185 | 190-230 | 230-290 | 195-245 |
| pH | 6.0-7.4 | >5.0 | 6.0-8.0 | 5.5-7.5 | 5.5-7.5 |
| Carbon | <1.0% | 2.0%-4.0% | 3.0%-5.0% | 2.0%-3.0% | 3.0%-4.0% |
| Content | | | | | |

### Example 5

The dynamic elastic mechanical properties of the cured test and comparison compounds are shown in Tables 4 and 5, where tan δ values were obtained from temperature sweep and/or strain sweep tests at different temperatures. For samples T-1 through T-5, and T-7, and their comparative examples, temperature sweep experiments were conducted at a frequency of 10 Hz using 0.5% strain for temperatures ranging from −70° C. to +90° C. For samples T-6 and comparative examples C-4 and C-5, temperatures sweep experiments were conducted at a frequency of 10 Hz using 0.5% strain for temperatures ranging from −70° C. to +10° C. and 2.0% strain at temperatures ranging from +10° C. to +100° C.

As discussed above, the tan δ values at 0° C. is not a very good predictor of wet traction. Nevertheless, from temperature sweeps, as reported in Tables 4 and 5, all of the test compounds employing DS-treated fumed silica as reinforcing filler exhibit higher tan δ values at 0° C., at the selected strain level, than their carbon black reinforced comparison compounds. Moreover, at 50° C., the tan δ values of the test compounds are lower than those of the carbon black comparison compounds, as would be expected for an improvement in rolling resistance.

### Example 6

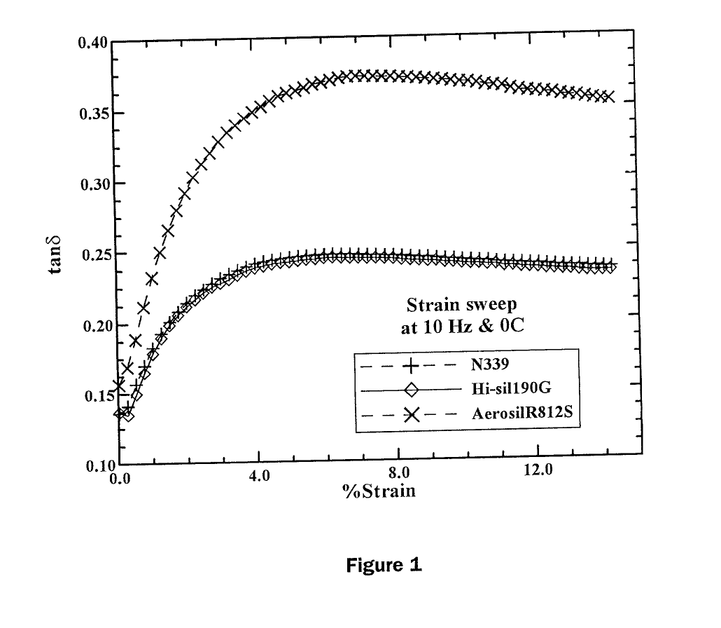

A better indicator of tan δ values at 0° C. and greater than 45° C. (e.g., 70° C.) is obtained from strain sweeps. For these studies, strain sweeps were conducted at 0° C. and 70° C. at a frequency of 10 Hz with strain sweeping from 0.025% to about 15%. The tan δ and dynamic elastic modulus (G′) were obtained from the strain sweep tests, and are illustrated in FIGS. 1 and 2, and FIGS. 3 and 4, respectively. The illustrated test results are for rubber compounds T-5 (reinforced with Aerosil®R812S), C-1 (reinforced with N339 carbon black) and C-3 (reinforced with HiSil-190G in the presence of 10% by weight, based on the silica, of Si69).

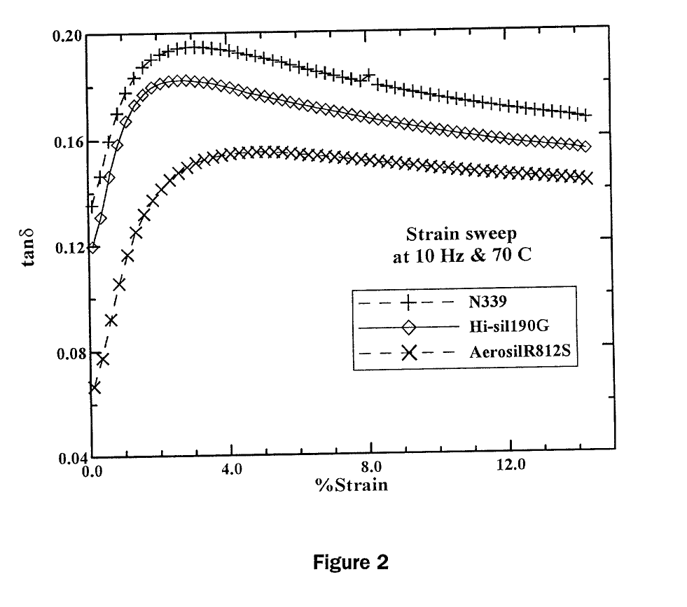

As illustrated in FIG. 1, the tan δ at 0° C. is higher for the SBR compound containing Aerosil®R812S at every strain level, compared to the carbon black (N339) reinforced and precipitated silica (HiSil-190G) reinforced compounds. Moreover, as illustrated in FIG. 2, the tan δ at 70° C. is lower for the compound containing Aerosil®R812S at every strain level, compared to the carbon black (N339) reinforced and precipitated silica (HiSil-190G) reinforced compounds, correlating with improved rolling resistance in the HMDS-treated fumed silica reinforced compound.

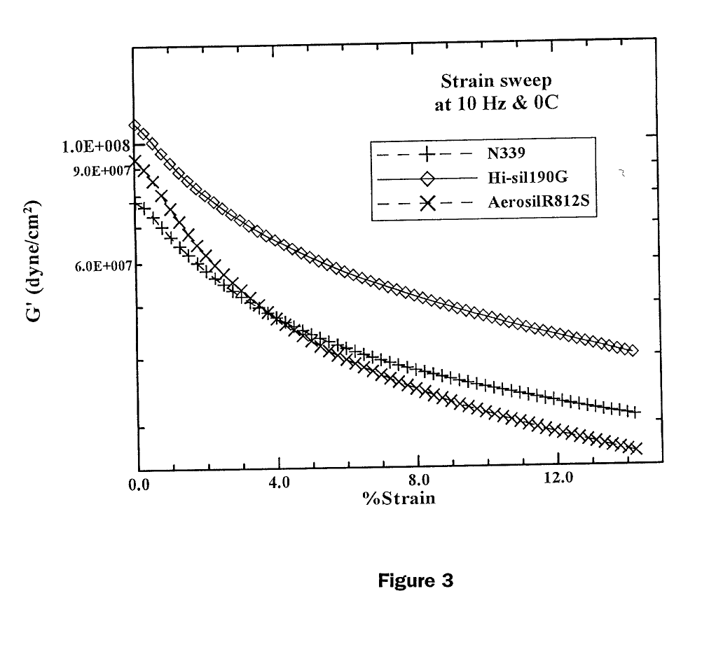

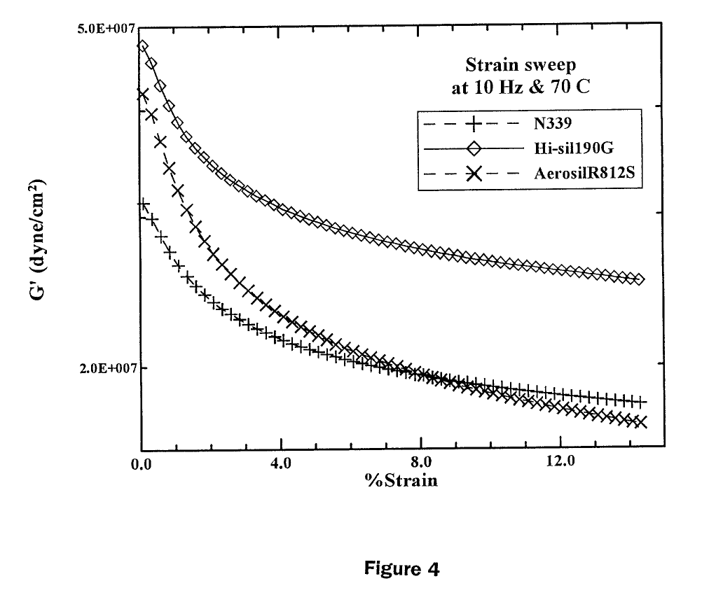

FIGS. 3 and 4 illustrate the dynamic elastic modulus (G′) obtained from the strain sweeps. The G′ has sometimes been used as an indicator of tire handling performance and a higher G′ at higher strains is thus desired. However, as expected, the G′ of the Aerosil®R812S-treated fumed silica reinforced SBR compound is lower than the precipitated silica (HiSil-190G) reinforced compound at all strain levels, illustrating the lack of silica filler aggregation due to the HMDS treatment. The treated fumed silica compound also has a lower G′ at high strain levels than both the carbon black (N339) filled compound and the HiSil-190G filled compound, indicating a decrease in resistance to deformation at high applied strains for the HS test compound, possibly because of the absence of polymer-filler bonds. The modulus can be improved by the addition of precipitated silica and/or carbon black and/or untreated fumed silica to augment the level of reinforcement, by the addition of a bifunctional silica coupling agent, or by additional sulfur.

### Example 7

The tensile mechanical properties of the test and comparison compounds were measured using the standard procedure described in ASTM-D 412 at room temperature. The tensile test specimens were Type 1 ring specimens having an inside circumference of 2.0 inches, a radial width of 0.04 inches, and a thickness of 0.075 inches. As illustrated by the results reported in Table 4, the modulus at the 50%, 100%, 200% and 300% strain levels for all test compounds (T-1 through T-6) is lower than that for the comparison carbon black filled compounds and precipitated silica filled compounds. These results are consistent with the strain sweep results shown in FIGS. 3 and 4. The low modulus is not the result of poor cure but can be improved by adjustment of the level of curatives. Rheological tests of Aerosil®R812, R812S and R8200-treated fumed silica filled compounds, using 1.3, 3.0 or 5.0 phr of sulfur, revealed normal elastic torque responses measured by the RPA 2000 curemeter (Alpha Technologies) over the cure testing periods employed at 165° C. (data not shown). The tensile mechanical properties, including tensile at break and percent strain at break, indicate that the compounds are not highly reinforced by the HMDS-treated fumed silica. Reinforcement can be improved by the addition of precipitated silica and/or carbon black and/or untreated fumed silica, by the addition of a bifunctional silica coupling agent, or by additional sulfur.

In conclusion, these examples have illustrated that the use of HMDS-treated fumed silica as reinforcing filler in rubber compounds for use in tire treads results in significant improvement in the wet traction of the treads compared to the wet traction of a similar tire tread comprising the same vulcanized rubber compound in which the treated silica is replaced at the same filler loading level by untreated carbon black, precipitated silica, mixtures thereof, and the like.

While the invention has been described herein with reference to the preferred embodiments, it is to be understood that it is not intended to limit the invention to the specific forms disclosed. On the contrary, it is intended that the invention cover all modifications and alternative forms falling within the scope of the appended claims.

I claim:

1. A vehicle tire having improved wet traction, having a tread comprising a vulcanized rubber compound that comprises:
(a) 100 parts by weight of an elastomer;
(b) about 5 phr to about 200 phr of a surface-treated siliceous or oxidic filler, wherein a plurality of hydroxyl groups on the filler surface prior to surface treatment have been replaced by —OSiR₁R₂R₃ groups, wherein R₁, R₂ and R₃ represent hydrocarbon chains having from one to about 20 carbon atoms;
(c) optionally about 5 phr to about 100 phr of an untreated reinforcing filler selected from the group consisting of silica, carbon black, and mixtures thereof;
(d) optionally about 0.1% to about 15% by weight of a bifunctional silica coupling agent, based on the weight of the untreated silica; and
(e) a cure agent including sulfur.

2. The tire of claim 1, wherein at least one of R₁, R₂ and R₃ is a methyl group.

3. The tire of claim 2, wherein R₁, R₂ and R₃ are methyl groups.

4. The tire of claim 1, wherein the surface-treated filler is selected from the group consisting of precipitated silica, fumed silica, colloidal silica, and mixtures thereof.

5. The tire of claim 4, wherein the surface-treated filler is fumed silica.

6. The tire of claim 1, wherein the surface-treated filler is selected from the group consisting of synthetic silicates, natural silicates, glass fibers, metal oxides, metal carbonates, metal hydroxides, and mixtures thereof.

7. The tire of claim 1, wherein the surface-treated filler comprises hexamethyldisilazane-treated silica.

8. The tire of claim 7, wherein the surface-treated filler comprises hexamethyldisilazane-treated fumed silica.

9. The tire of claim 1, wherein the elastomer is selected from the group consisting of homopolymers of conjugated diene monomers, and copolymers and terpolymers of the conjugated diene monomers with monovinyl aromatic monomers and trienes.

10. A vehicle tire having improved wet traction, having a tread comprising a vulcanized rubber compound that comprises:
(a) 100 parts by weight of an elastomer;
(b) about 5 phr to about 200 phr of a surface-treated silica filler, wherein a plurality of hydroxyl groups on the filler surface prior to surface treatment have been replaced by —OSi(CH₃)₃ groups;
(c) optionally about 5 phr to about 100 phr of an untreated reinforcing filler selected from the group consisting of silica, carbon black, and mixtures thereof;
(d) optionally about 0.1% to about 15% by weight of a bifunctional silica coupling agent, based on the weight of the untreated silica; and
(e) a cure agent including sulfur.

11. The tire of claim 10, wherein the surface-treated silica is selected from the group consisting of precipitated silica, fumed silica, colloidal silica, and mixtures thereof.

12. A vehicle tire having improved wet traction, having a tread comprising a vulcanized rubber compound that comprises:
(a) 100 parts by weight of an elastomer selected from the group consisting of homopolymers of conjugated diene monomers, and copolymers and terpolymers of the conjugated diene monomers with monovinyl aromatic monomers and trienes;
(b) about 5 phr to about 200 phr of a hexamethyldisilazane-treated silica;
(c) optionally about 5 phr to about 100 phr of an untreated reinforcing filler selected from the group consisting of silica, carbon black, and mixtures thereof;
(d) optionally about 0.1% to about 15% by weight of a bifunctional silica coupling agent, based on the weight of the untreated silica; and
(e) a cure agent including sulfur.

13. A vehicle tire having improved wet traction, having a tread comprising a vulcanized rubber compound that comprises:
(a) 100 parts by weight of an elastomer selected from the group consisting of homopolymers of conjugated diene monomers, and copolymers and terpolymers of the conjugated diene monomers with monovinyl aromatic monomers and trienes;
(b) about 5 phr to about 200 phr of a hexamethyldisilazane-treated fumed silica;
(c) optionally about 5 phr to about 100 phr of an untreated reinforcing filler selected from the group consisting of silica, carbon black, and mixtures thereof;
(d) optionally about 0.1% to about 15% by weight of a bifunctional silica coupling agent, based on the weight of the untreated silica; and
(e) a cure agent including sulfur.

14. A method to improve the wet traction of a tire tread, comprising:
(a) mixing together
(i) 100 parts by weight of an elastomer selected from the group consisting of homopolymers of conjugated diene monomers, and copolymers and terpolymers of the conjugated diene monomers with monovinyl aromatic monomers and trienes,
(ii) about 5 phr to about 200 phr of a surface-treated siliceous or oxidic filler, wherein a plurality of hydroxyl groups on the filler surface prior to surface treatment have been replaced by —OSiR₁R₂R₃ groups, wherein R₁, R₂ and R₃ represent hydrocarbon chains having from one to about 20 carbon atoms,
(iii) optionally about 5 phr to about 100 phr of an untreated reinforcing filler selected from the group consisting of silica, carbon black, and mixtures thereof;
(iv) optionally about 0.1% to about 15% by weight of a bifunctional silica coupling agent, based on the weight of the untreated silica; and
(v) a cure agent including sulfur;
(b) vulcanizing the mixture to obtain vulcanized rubber; and
(c) producing a tire tread from the vulcanized rubber.

15. The method of claim 14, wherein at least one of R₁, R₂ and R₃ is a methyl group.

16. The method of claim 15, wherein R₁, R₂ and R₃ are methyl groups.

17. The method of claim 14, wherein the surface-treated filler is selected from the group consisting of precipitated silica, fumed silica, colloidal silica, and mixtures thereof.

18. The method of claim 17, wherein the surface-treated filler is fumed silica.

19. The method of claim 14, wherein the surface-treated filler is selected from the group consisting of synthetic silicates, natural silicates, glass fibers, metal oxides, metal carbonates, metal hydroxides, and mixtures thereof.

20. The method of claim 14, wherein the surface-treated filler comprises hexamethyldisilazane-treated silica.

21. The method of claim 14, wherein the surface-treated filler comprises hexamethyldisilazane-treated fumed silica.

22. A method to improve the wet traction of a tire tread, comprising:
(a) mixing together
(i) 100 parts by weight of an elastomer selected from the group consisting of homopolymers of conjugated diene monomers, and copolymers and terpolymers of the conjugated diene monomers with monovinyl aromatic monomers and trienes,
(ii) about 5 phr to about 200 phr of a surface-treated silica filler, wherein a plurality of hydroxyl groups on the filler surface prior to surface treatment have been replaced by —OSi(CH₃)₃ groups,
(iii) optionally about 5 phr to about 100 phr of an untreated reinforcing filler selected from the group consisting of silica, carbon black, and mixtures thereof;
(iv) optionally about 0.1% to about 15% by weight of a bifunctional silica coupling agent, based on the weight of the untreated silica; and
(v) a cure agent including sulfur;
(b) vulcanizing the mixture to obtain a vulcanized rubber; and
(c) producing a tire tread from the vulcanized rubber.

23. A method to improve the wet traction of a tire tread, comprising:
(a) mixing together
(i) 100 parts by weight of an elastomer,
(ii) about 5 phr to about 200 phr of a filler comprising hexamethyldisilazane-treated fumed silica,
(iii) optionally about 5 phr to about 100 phr of an untreated reinforcing filler selected from the group consisting of silica, carbon black, and mixtures thereof;
(iv) optionally about 0.1% to about 15% by weight of a bifunctional silica coupling agent, based on the weight of the untreated silica; and
(v) a cure agent;
(b) vulcanizing the mixture to obtain a vulcanized rubber; and
(c) producing a tire tread from the vulcanized rubber.

24. A vulcanizable rubber composition for use as treadstock in order to improve the wet traction of tire treads, comprising:
(a) 100 parts by weight of an elastomer;
(b) about 5 phr to about 200 phr of a surface-treated siliceous or oxidic filler, wherein a plurality of hydroxyl groups on the filler surface prior to surface treatment have been replaced by —OSiR₁R₂R₃ groups, wherein R₁, R₂ and R₃ represent hydrocarbon chains having from one to about 20 carbon atoms;
(c) optionally about 5 phr to about 100 phr of an untreated reinforcing filler selected from the group consisting of silica, carbon black, and mixtures thereof;
(d) optionally about 0.1% to about 15% by weight of a bifunctional silica coupling agent, based on the weight of the untreated silica; and
(e) a cure agent including sulfur.

25. The composition of claim 24, wherein at least one of R₁, R₂ and R₃ is a methyl group.

26. The composition of claim 25, wherein R₁, R₂ and R₃ are methyl groups.

27. The composition of claim 24, wherein the surface-treated filler is selected from the group consisting of precipitated silica, fumed silica, colloidal silica, and mixtures thereof.

28. The composition of claim 27, wherein the surface-treated filler is fumed silica.

29. The composition of claim 24, wherein the surface-treated filler is selected from the group consisting of synthetic silicates, natural silicates, glass fibers, metal oxides, metal carbonates, metal hydroxides, and mixtures thereof.

30. The composition of claim 24, wherein the surface-treated filler comprises hexamethyldisilazane-treated silica.

31. The composition of claim 30, wherein the surface-treated filler comprises hexamethyldisilazane-treated fumed silica.

32. The composition of claim 24, wherein the elastomer is selected from the group consisting of homopolymers of conjugated diene monomers, and copolymers and terpolymers of the conjugated diene monomers with monovinyl aromatic monomers and trienes.

33. A vulcanizable rubber composition for use as treadstock in order to improve the wet traction of tire treads, comprising:
(a) 100 parts by weight of an elastomer;
(b) about 5 phr to about 200 phr of a surface-treated silica filler, wherein a plurality of hydroxyl groups on the filler surface prior to surface treatment have been replaced by —OSi(CH₃)₃ groups;
(c) optionally about 5 phr to about 100 phr of an untreated reinforcing filler selected from the group consisting of silica, carbon black, and mixtures thereof;
(d) optionally about 0.1% to about 15% by weight of a bifunctional silica coupling agent, based on the weight of the untreated silica; and
(e) a cure agent including sulfur.

34. The composition of claim 33, wherein the surface-treated silica filler comprises fumed silica.

35. A vulcanizable rubber composition for use as treadstock in order to improve the wet traction of tire treads, comprising:
(a) 100 parts by weight of an elastomer selected from the group consisting of homopolymers of conjugated diene monomers, and copolymers and terpolymers of the conjugated diene monomers with monovinyl aromatic monomers and trienes;
(b) about 5 phr to about 200 phr of a hexamethyldisilazane-treated silica;
(c) optionally about 5 phr to about 100 phr of an untreated reinforcing filler selected from the group consisting of silica, carbon black, and mixtures thereof;
(d) optionally about 0.1% to about 15% by weight of a bifunctional silica coupling agent, based on the weight of the untreated silica; and
(e) a cure agent including sulfur.

36. A vulcanizable rubber composition for use as treadstock in order to improve the wet traction of tire treads, comprising:
(a) 100 parts by weight of an elastomer selected from the group consisting of homopolymers of conjugated diene monomers, and copolymers and terpolymers of the conjugated diene monomers with monovinyl aromatic monomers and trienes;
(b) about 5 phr to about 200 phr of a hexamethyldisilazane-treated fumed silica;
(c) optionally about 5 phr to about 100 phr of an untreated reinforcing filler selected from the group consisting of silica, carbon black, and mixtures thereof;
(d) optionally about 0.1% to about 15% by weight of a bifunctional silica coupling agent, based on the weight of the untreated silica; and
a cure agent including sulfur.
